(19) United States
(12) Patent Application Publication
(10) Pub. No.: US 2006/0212355 A1
(43) Pub. Date: Sep. 21, 2006

(54) Social information and promotional offer management and distribution systems and methods

(76) Inventors: Brian Teague, Dallas, TX (US); Daniel Wagstaff, Dallas, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 11/438,962

(22) Filed: May 23, 2006

Related U.S. Application Data
(63) Continuation-in-part of application No. 11/339,893, filed on Jan. 26, 2006.
(60) Provisional application No. 60/647,284, filed on Jan. 27, 2005.

(51) Int. Cl. G06Q 30/00

(52) U.S. Cl. 705/14

(57) ABSTRACT

Methods and systems for social information and promotional offer generation and distribution are provided. A system comprises a merchant database comprising merchant information and organized into merchant accounts by a plurality of unique merchant identifying codes. A social seller database comprises social seller information and is organized into social seller accounts by a plurality of unique social seller identifying codes. A promotional offer database comprises promotional offer information and is organized into promotional offer records by a plurality of unique promotional offer identifying codes. A social selling server couples to the merchant database, the social seller database, and the promotional offer database, and is configured to link one or more promotional offer records in the promotional offer database with a merchant account in the merchant database, to link a social seller account to a promotional offer record based on the promotional offer record, to provide promotional offer indicia to a social seller associated with a linked social seller account, to receive completed transaction information for a purchase influenced by the social seller, and to update the merchant database, the social seller database, and the promotional offer database based on received completed transaction information.

This application claims priority and the benefit under 35 U.S.C. § 20 from U.S. non-provisional patent application 11/339,893 for “Information and Promotional Offer Management and Distribution Systems and Methods,” filed Jan. 26, 2006, which is hereby incorporated by reference. Application Ser. No. 11/339,893 claims priority and the benefit under 35 U.S.C. § 119(e) from U.S. provisional patent application 60/647,284 for “System and Method for the Requesting (opt-in) and Subsequent Distribution of Offers Via Email and SMS—Text Messaging,” filed Jan. 27, 2005, which is hereby incorporated by reference.

### BACKGROUND

1. Field of the Invention

The present invention relates generally to information distribution and in particular to social information and promotional offer management and distribution systems and methods.

2. Description of Related Art

Modern mass marketing and information delivery systems typically provide information and advertising that encourages the recipient to purchase the advertised products and/or services. In one sense, every advertisement or “ad” is a contractual offer to the consumer. Generally, “pure” ads offer the promise of good times or good feelings if the consumer purchases the product/service. However, many ads are more expressly offers, promising a discounted price or free goods and/or services if the consumer purchases the underlying product/service. A print flyer with an attached coupon is a simple example of offer-type advertisements. Consumers using coupons are promised a price discount in exchange for purchasing the advertised product.

Advertising offers are typically distributed in a variety of ways. Radio and television ads, for example, are massively distributed. Because there is no print capability in radio or television, these advertisements are typically closer to pure ads. Additionally, broadcast ads cannot be restricted to subsets within the viewing/listening audience—everyone in the audience sees and/or hears the ads. Broadcast media is also very expensive.

Print media also typically include advertisements and more often also include printed offers with detachable coupons that are slightly more narrowly targeted to those consumers who ordinarily read the medium (for example, fashion magazine subscribers or automobile enthusiasts). But typical print media cannot be easily restricted to a subset of the subscribers/readers. As with broadcast media, the advertisements are shown to anyone who picks up the magazine or newspaper. Print advertising/offer distribution is also very expensive. Further, consumers typically must remove the coupon and physically present it to a merchant for redemption. This restricts the number of coupons available in a single copy of a print medium. Moreover, consumers must remember to keep track of the coupon.

Recently, the advent of the Internet has introduced more narrowly focused targeted advertising—for example, tracking cookies and purchase/browsing histories attempt to determine what ads a consumer might be less uninterested in seeing. Further technological advances including email and cell phones have brought new avenues for advertisement and communication with customers. These avenues remain substantially under-utilized. Furthermore, unscrupulous and sharp business practitioners have been massively abusing the more recent technological advancements in communications.

In particular, the prevalence of electronic mail users resulted in the development of a number of operations that send massively distributed, wholly untargeted and unsolicited commercial email, often over the express and repeated objections of the recipients. This phenomenon of unsolicited commercial email (UCE) or “spam” has spilled over into fixed-site text messaging and mobile telephony. Worse, much of this spam is fraudulent, wholly unsuitable for the recipient, proposes illegal activity bothersome, voluminous, obnoxious, and/or otherwise provides a negative incentive to the recipient to purchase the advertised product or take advantage of the offer. Further, spam is not typically targeted to primarily those consumers that might be interested in the product, and is instead sent to every known consumer in the database. Besides providing a drain on resources and causing waste of countless millions of dollars annually in virus propagation and spam prevention, spam provides a very low advertisement-to-sale ratio and is very inefficient.

Efforts to regulate spam through government intervention have met with mixed results. One framework to handle the increasing cost of spam is the distinction between “opt-in” and “opt-out” marketing databases. Generally, “opt-in” requires consumers to affirmatively request to be put on an ad distribution list, while “opt-out” allows marketers to send unsolicited advertisements until the consumer opts out of the list. Both methods are subject to abuse. The worst spam offenders follow neither system and do not care whether the consumer opts-in or out. More modern tyrants of spam, however, propose an opt-out method where consumers are subjected to a barrage of spam until they can expressly request not to be so assaulted.

Opt-in systems were therefore designed to require express permission to send advertisements to the consumer. Rarely do consumers actually opt-in to receive advertisements alone. Typically, consumers only opt-in when they desire programming and/or content that is also accompanied by ads, not the ads themselves. Some consumers are willing to tolerate the ads if only to access the desired content.

However, even with opt-in advertising, consumers have unmet demands, or demands of which they are unaware until presented with options. Moreover, consumers have privacy concerns-they do not want casual observers to be aware of their desires or the types of information, good, and/or services they seek. Similarly, consumers also have security concerns—they do not want their private information to be accessible to anyone without their express permission.

Further, consumers very much do not want to be bothered by unwanted ads in undesirable formats. Typical systems for opt-in advertising do not provide a mechanism whereby a user can specify whether they would prefer to receive offers via text message, email, voicemail, etc. As a majority of consumers have cell phones and other mobile devices, the ability to provide desired offers and promotional information though these mobile devices remains largely untapped. Thus, advertisers have a need for the ability to efficiently, effectively, and discreetly communicate not only the terms of an offer but the instructions within an offer via email or text messaging to a user's mobile device.

With increased focus on technology-driven advertisement, however, the importance of interpersonal human contact has been overlooked as an aspect or complement of technology-driven advertisement. As described above, retailers and merchants typically look to traditional forms of advertising, such as radio, television, print, and the Internet to elevate their brands and increase their market share. Faced with more competitors in the marketplace and ever-increasing demand to improve sales, marketers are looking for extra-traditional means of advertising and marketing.

For example, some advertisers pay marketers to hire actors to “talk up” certain products and services in social settings. The underlying idea is that people will overhear the actor's conversation and endorsement, which increases the probability that the eavesdroppers will be influenced to make a buying decision based in part on that one-time encounter. While this method is simple to implement, it is very difficult to track, which therefore implies a zero return on advertising investment.

A need exists, therefore, for social information and promotional offer management and distribution systems and methods that overcome problems and disadvantages associated with prior systems and methods.

All references cited herein are incorporated by reference to the maximum extent allowable by law. To the extent a reference may not be fully incorporated herein, it is incorporated by reference for background purposes and indicative of the knowledge of one of ordinary skill in the art.

### SUMMARY

The problems presented in previous systems and methods are solved by the systems and methods of the present invention. In accordance with one embodiment of the present invention, social information and promotional offer management and distribution systems and methods are provided.

In particular, in one embodiment, a system comprises a merchant database comprising merchant information and organized into merchant accounts by a plurality of unique merchant identifying codes. A social seller database comprises social seller information and is organized into social seller accounts by a plurality of unique social seller identifying codes. A promotional offer database comprises promotional offer information and is organized into promotional offer records by a plurality of unique promotional offer identifying codes. A social selling server couples to the merchant database, the social seller database, and the promotional offer database, and is configured to link one or more promotional offer records in the promotional offer database with a merchant account in the merchant database, to link a social seller account to a promotional offer record based on the promotional offer record, to provide promotional offer indicia to a social seller associated with a linked social seller account, to receive completed transaction information for a purchase influenced by the social seller, and to update the merchant database, the social seller database, and the promotional offer database based on received completed transaction information.

In an alternate embodiment, a social information and promotional offer distribution and management method comprises establishing a merchant account in electronic form associated with a merchant. A social seller account is established in electronic form and associated with a social seller. A promotional offer is established in electronic form and linked to the merchant account. The social seller account is linked to the promotional offer and indicia of the promotional offer are provided in electronic form to the social seller. An influenced purchase based on the provided indicia is identified, the influenced purchase being a result of promoting by the social seller the promotional offer among a social network associated with the social seller and the social seller transferring the provided indicia. The merchant account is updated based on the influenced purchase and the social seller account is updated based on the influenced purchase.

One advantage of the present invention is the ability to efficiently, effectively, and discreetly communicate not only the terms of an offer but the instructions within an offer to a user's mobile device. Another advantage is the ability for a user to not only request an offer but to have the offer sent to them via email, SMS-text message, and/or other desired delivery methods. Another advantage is to provide the user with a quick and easy 1-step or 2-step process to receive a requested offer.

Another advantage of the present invention is the ability to support improved social selling methods with improved information and/or offer distribution systems. Still another advantage of the present invention is the ability to provide a trackable and manageable method and system for monitoring social selling operations. Yet another advantage is the ability to provide a trackable and manageable incentive program that automatically encourages social sellers to perform in ways advantageous to an advertiser.

Still another advantage of the present invention is the ability to provide a human element that softens the harsh technological sales approaches in a manageable system that also allows for customizable and concrete embodiment in a system. Another technical advantage is the ability to provide an automated method and system that improves a merchant's ability to create, track, and manage both spontaneous offers and social branding. Yet another technical advantage is the ability to provide an automated method and system that improves a merchant's ability to customize the particular requirements to qualify a social seller to promote the product. Still another technical advantage is the ability to track the performance and compensation of a social seller.

Other objects, features, and advantages of the present invention will become apparent with reference to the drawings and detailed description that follow.

### BRIEF DESCRIPTION OF THE DRAWINGS

FIG. 1 is a block diagram illustrating a social information and promotional offer management and distribution system in accordance with one embodiment of the present invention.

FIG. 2 is a block diagram illustrating a social information distribution system in accordance with one embodiment of the present invention.

FIG. 3 is a block diagram illustrating a content management system in accordance with one embodiment of the present invention.

FIG. 4 is a block diagram illustrating a social selling server/hub in accordance with one embodiment of the present invention.

FIG. 5 is a flow diagram illustrating a social information and promotional offer management and distribution method in accordance with one embodiment of the present invention.

FIG. 6 is a flow diagram illustrating a social information and promotional offer management and distribution method in accordance with one embodiment of the present invention.

### DETAILED DESCRIPTION

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

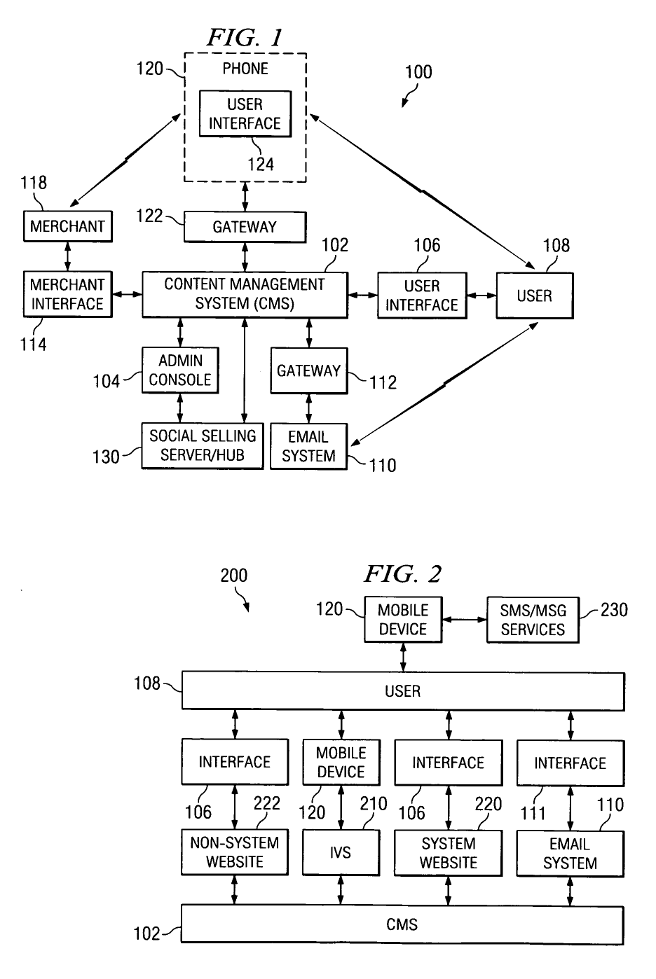

Referring now to FIG. 1, the reference numeral 100 generally designates a social information and promotional offer management and distribution system in accordance with one embodiment of the present invention. System 100 includes content management system (CMS) 102, described in additional detail below. Generally, CMS 102 is a hardware or software system, such as, for example, a server, that includes various modules that store data, process data, and distribute information and promotional offers, among other things.

CMS 102 couples to an administrative console 104. Administrative console 104 is configured to allow a user to access and manipulate the data stored in CMS 102 and social selling server/hub 130, and to perform other tasks. Administrative console 104 can be, for example, a stand-alone workstation, a graphical user interface (GUI) embedded in a desktop computer, or other suitable interface. In one embodiment, administrative console 104 is configured to allow an owner of system 100 to customize and/or maintain one or more of the components of system 100.

System 100 also includes a user interface 106. User interface 106 couples to CMS 102 and in one embodiment is a GUI coupled to CMS 102 through the Internet. Generally, user interface 106 is configured to allow a user 108 to interact with one or more modules of CMS 102. As described in more detail below, user interface 106 is also generally configured to allow a user 108 to interact with one or more modules of social selling server/hub 130. In a particular embodiment, user interface 106 is configured to receive user information from user 108 and to transmit received user information to CMS 102. As described in more detail below, the user information can be collected by CMS 102 and stored in a database. Moreover, the collected user information can be organized into a user profile and can contain, for example, user contact information, user promotional offer type preference information, user promotional offer delivery preference information, and other suitable information.

In the illustrated embodiment, user 108 also has access to an email system 110. Email system 110 is an otherwise conventional electronic mail delivery system and can include an email display/creation GUI or “client,” and an email distribution hub or server. CMS 102 is configured to access email system 110 through a gateway 112. Gateway 112 is an otherwise conventional electronic mail gateway.

System 100 also includes a merchant interface 114. Merchant interface 114 couples to CMS 102 and in one embodiment is a GUI coupled to CMS 102 through the Internet. Generally, merchant interface 114 is configured to allow a merchant 118 to interact with one or more modules of CMS 102. In a particular embodiment, merchant interface 114 is configured to receive merchant information from merchant 118 and to transmit received merchant information to CMS 102. As described in more detail below, the merchant information can be collected by CMS 102 and stored in a database. Moreover, the collected merchant information can be organized into a merchant profile and/or an offer profile and can contain, for example, merchant contact information, directions to the merchant's place of business, the type of business, merchant promotional offer type preference information, merchant promotional offer delivery preference information, merchant referral codes, the terms of one or more promotional offers sponsored by the merchant, and other suitable information.

In the illustrated embodiment, user 108 also has access to a mobile device 120, which is configured to send information to and receive information from CMS 102 through gateway 122. Gateway 122 is an otherwise conventional mobile device gateway. In the illustrated embodiment, and for ease of explanation, mobile device 120 is depicted as a mobile or “cellular” telephone. One skilled in the art will understand that mobile device 120 can also be a wireless personal data assistant (PDA), a wireless email device, or other suitable mobile device. Generally, mobile device 120 is an otherwise conventional mobile device, described in further detail below.

Mobile device 120 includes a user interface 124. Generally user interface 124 is an otherwise conventional mobile device user interface and is configured to allow user 108 to access various features in operation of mobile device 120. In the illustrated embodiment, user interface 124 can include a GUI configured for Internet applications, and can be configured to run applications coded in, for example, extended markup language (XML), hyper-text markup language (HTML), Java, Flash, or other suitable Internet-based programming languages. Moreover, mobile device 120 is also configured to interact with an interactive voice recognition (IVR) system of CMS 102.

In a particular embodiment, one or more of user interface 124 and/or merchant interface 114 can be configured as a “Mobile Offer Management (MOM)” module, described in more detail below. When configured as a merchant interface 114, for example, the MOM module can be employed to allow a merchant to create their own coupon inventory, manage their own users and groups as well as control the frequency of coupon pushes. As used herein, a “coupon” will also be described as a “mobile offer” where appropriate. A merchant 118 can also employ the MOM module to create their own coupon inventory for their own 1-click online campaigns, described in more detail below. When configured as a user interface 124, for example, the MOM module can be employed to allow a social seller to create customized referral messages, manage social contacts and groups as well as control the frequency of reminder messages and/or offers. Further, in one embodiment, a social seller can employ user interface 124 to review and attach to one or more PSE promotional offers.

So configured, system 100 can be operated as an information and promotional offer management and distribution system. That is, generally, in operation, in one embodiment system 100 operates as follows. User 108 creates a user profile on CMS 102 through user interface 106, containing contact and other identifying information and the user's preferences for offer content and delivery. The user can subsequently modify any of the information in the user profile, except information added by the CMS 102 itself, such as tracking information, as described in more detail below. Specifically, the user profile also includes tracking and statistical information relating to, for example, the number of offers the user has requested, the number of offers the user has redeemed, the time of day or day of the week when the user requests/redeems offers, the type of offer, and/or other suitable information.

A merchant 118 creates a merchant profile on CMS 102 as well as an offer profile through merchant interface 114. As described in additional detail below, the merchant profile contains similar information as the user profile. The offer profile contains details specific to a particular offer sponsored by the merchant, including, for example, the terms of the offer, expiration settings, tracking information, and other suitable information.

Subsequent to establishing a user profile on CMS 102, user 108 initiates a mobile telephone call to CMS 102 through mobile device 120 though gateway 122. In one embodiment, user 108 is connected to an IVS of CMS 102. In response to received user information, CMS 102 generates and transmits offers to the user. In one embodiment, CMS 102 searches an offer database for offers that meet either pre-defined user criteria (from the user's profile), or newly input criteria generated in response to questions presented to the user while interacting with the system. When a matching offer is found, CMS 102 generates a tracking code, embeds the tracking code in a message to the user, and sends the message to the user's desired destination device, such as, for example, the user's cell phone/SMS receiver and/or the user's email address.

The received message with the embedded tracking code serves as the coupon and is displayed as an image in a GUI within user interface 124. As described above, a “coupon” can also be described as a “mobile offer” herein. For ease of illustration and consistency of verbiage, however, the term “coupon” will be employed in most instances. No limitation is intended thereby. In a preferred embodiment, user 108 selects a destination from a list of options, such as, for example, a restaurant, and CMS 102 presents user 108 with one or more offers corresponding to that restaurant. In one embodiment the embedded tracking code is an alphanumeric code. In an alternate embodiment, the embedded tracking code is a bar code. In one embodiment, the embedded tracking code contains information uniquely identifying the merchant associated with the promotional offer. In an alternate embodiment, the embedded tracking code includes referral information. In an alternate embodiment, CMS 102 generates and embeds a separate referral tracking code, which includes referral information. One skilled in the art will understand that other configurations can also be employed.

Subsequently, user 108 presents the received coupon to merchant 118. Merchant 118 verifies the tracking code through merchant interface 114 and, upon a determination that the coupon is still valid, honors the coupon. CMS 102 updates the offer status and tracks the transaction. Subsequently, merchant 118, through CMS 102, reconciles the coupons allowed with the coupons issued and redeemed. Further reconciliation includes referral transactions and merchant payment to the system operator.

Generally, in an alternate embodiment, in operation, system 100 operates as follows. User 108 dials a predetermined telephone number and connects to an interactive voice recognition (IVR) system of CMS 102. The IVR system presents one or more offers to user 108. Once an offer is heard that appeals to user 108, user 108 can select the offer through user interface 124, and can elect to receive the offer via SMS-text message to phone 120 or via email through email system 110. As above, user 108 presents phone 120 to the merchant 118 that initiated the offer and in turn, receives the terms of the offer embedded in the SMS-text message. Alternately, user 108 connects to CMS 102 through user interface 106 through a website on the Internet. User 108 clicks on an offer through a GUI and is given the option of receiving the offer via email through email system 110 or SMS-text message to phone 120. If the offer is sent via email, user 108 prints the offer and presents the offer to merchant 118. If the offer is sent via SMS-text message, user 108 presents phone 120 (specifically user interface 124) to merchant 118 and in turn, receives the terms of the offer embedded in the SMS-text message.

Additionally, in one embodiment system 100 is configured to deliver to user 108 requested non-offer information, such as, for example, directions to a place of business for merchant 118, notices of special events, and other suitable information. In an alternate embodiment, system 100 is configured to forward reservation information and/or to initiate a live chat session between user 108 and merchant 118 through mobile device 120.

While the above embodiment has been described primarily with respect to SMS-text messaging, one skilled in the art will understand that the present invention is not restricted to SMS-text messaging. Further, any suitable information delivery mechanism can also be employed, including, but not limited to, MMS, and/or other next generation mobile messaging system, such as, for example, a Palm Treo®, a Blackberry®, or other suitable mobile device configured for text and/or electronic mail messaging.

In addition to the above information and promotional offer management and delivery operations, system 100 is also configured for social information and promotional offer management and delivery operations, or “social selling” operations. As illustrated, system 100 also includes Social Selling Server/Hub (SSS/H) 130, described in additional detail below. Generally, SSS/H 130 is a hardware or software system, such as, for example, a server, that includes various modules that store data, process data, and distribute social selling information and promotional offers, among other things.

Generally, as used herein, a “social network” is a network of people who connect, identify, and share with each other through either traditional social settings, such as, for example, bars or coffee shops, or through technology such as the Internet, text messaging, telephone, personal data assistant (“PDA”) etc. Generally, as used herein, “social branding” is the process of branding a certain product, service, or entertainment (hereinafter, “PSE”) through promotion and use within a social network. Generally, as used herein, “social selling” is the process of connecting people to PSE, influencing a buying decision, and receiving compensation for that influence.

In the illustrated embodiment, SSS/H 130 is depicted as coupled to administrative console 104 and CMS 102. Thus, in the illustrated embodiment, access to SSS/H 130 is generally through either CMS 102 or administrative console 104. In an alternate embodiment, for example, user interface 106 also couples to SSS/H 130 and in one embodiment is a GUI coupled to SSS/H 130 through the Internet. Thus, user interface 106 can be configured to allow a user 108 to interact with one or more modules of SSS/H 130. In a particular embodiment, user interface 106 is configured to receive user information from user 108 and to transmit received user information to SSS'H 130 through CMS 102. One skilled in the art will understand that user interface 106 can also be configured to receive user information from user 108 and to transmit received user information directly to SSS/H 130.

As described in more detail below, the user information can be collected by SSS/H 130 and stored in a database. Moreover, the collected user information can be organized into a user profile and can contain, for example, user contact information, user promotional offer type preference information, user promotional offer delivery preference information, and other suitable information. As described in additional detail below, the collected user information can be duplicative of the user information stored in CMS 102, and can include additional social selling information. In an alternate embodiment, general user information is stored in CMS 102 and user social selling information can be stored in SSS/H 130. One skilled in the art will understand that other configurations can also be employed.

Additionally, one skilled in the art will understand that other couplings and connections to SSS/H 130 can also be employed. For example, in the illustrated embodiment, merchant interface 114 couples to SSS/H 130 through CMS 102. In an alternate embodiment, merchant interface 114 can also be configured to couple directly to SSS/H 130. Similarly, gateway 112 and/or gateway 122 can also couple directly to SSS/H 130.

So configured, system 100 can be operated as a social information and promotional offer management and distribution system. In particular, in one embodiment, a merchant 118 establishes a social selling account on SSS/H 130. The social selling account can include the basic merchant information stored on CMS 102, with additional information related to social selling and social branding, as described in more detail below. Similarly, a user 108 establishes a social seller account on SSS/H 130. The social seller account can include the basic user information stored on CMS 102, with additional information related to social selling and social branding, as described in more detail below.

A merchant 118 that has established a social selling account can subsequently establish a social selling PSE account and/or offer on SSS/H 130. Generally, a social selling PSE offer includes terms, conditions, and other pertinent information related to a particular PSE the merchant would like to promote through social selling, as described in more detail below. Subsequently, a user 108 who has established a social seller account can attach to a particular social selling PSE offer. Generally, as described in more detail below, a user can select from a variety of active PSE offers and “attach” or otherwise agree to promote the particular PSE, in exchange for the promised rewards detailed in the PSE offer.

Having attached to a particular PSE offer, the user 108 (now, a “social seller” or “social salesman”) can promote the PSE to his/her friends, family and peer group (FF&PG) (not shown). Generally, the promotion by a social seller can also be employed in addition to traditional advertising. For example, from the early days of the very first commercial advertisement, advertisers would distribute their message and attract primarily the early adopters. The early adopters would then indirectly influence their friends, family, and anyone in their peer network to purchase the same PSE. However, the early adopters would typically not receive any guidance or direction in their influence, or receive any compensation for their efforts. In the embodiments of the present invention, this influence is guided and express, and encouraged, and successful social sellers are compensated for their efforts. Further, additional distinguishing advantages and features are described in more detail below.

After some period of time during which the social seller is promoting the PSE, one of the social seller's FF&PG will eventually agree to purchase the promoted PSE. In response, in one embodiment, user 108 can request a customized coupon from CMS 102 and/or SSS/H 130, to be delivered to either user 108 or the prospective buyer, through mobile device 120, email system 110, and/or user interface 106. As described in more detail below, the customized coupon can include embedded tracking and/or referral information that links the social seller to the ultimate purchase by the prospective buyer. In an embodiment where the customized coupon is delivered to user 108, user 108 can subsequently pass on the customized coupon to his/her prospective buyer for use in the purchase.

The prospective buyer can then use the customized coupon to purchase the promoted PSE. In one embodiment, the merchant 118 records the customized coupon information at the point of sale. In one embodiment, merchant 118 employs a specially designed point-of-sale (POS) device to scan in a bar code embedded in the customized coupon. In an alternate embodiment, merchant 118 records the customized coupon information at some point in time after the time of sale. In one embodiment, merchant 118 records the transaction and the customized coupon information through merchant interface 114. In an alternate embodiment, merchant 118 can transmit physical copies of the customized coupon to the owner/operator of system 100 for further processing.

Once the social sale has been recorded in the system, that is, the pertinent information is recorded and/or stored in SSS/H 130, various tracking databases are updated. Additionally, the operator of SSS/H 130 and/or system 100 can also apply pre-determines service or usage fees. For example, as described in more detail below, SSS/H 130 can be configured to track and/or manage a wide variety of variables and information, such as, the total number of units sold through social branding, the total social sales made by a social seller, the total rewards or other compensation paid to a particular social seller or for a particular PSE offer, and other suitable data points. Thus, so configured, SSS/H 130 can provide a wide array of tools to track and manage a merchant's return-on-investment for social selling promotional operations.

For example, in one embodiment, recording a social sale in SSS/H 130 includes updating the PSE offer database, the social seller profile, the merchant profile, and a general tracking database. In a particular embodiment, SSS/H 130 can record a pending compensation transaction to the social seller, based upon a pre-determined time window, to allow for possible returns of purchased products. For example, SSS/H 130 can be configured to withhold actual payment to a social seller until 91 days after a social sale is consummated. This and other configurations are discussed in additional detail below.

This process can be repeated as often as desired. As a merchant adds new PSE to a social branding/selling operation, new PSE offers can be created, and new or existing social sellers can attach to desirable PSE offers in a highly customizable manner. In this way, matching appropriate social sellers with products can be highly self-selective. As such, social sellers are more likely to endorse the PSE they are promoting honestly and thoroughly, which leads to more enthusiastic promotion. Further, as the pool of social sellers expands, this self-selection and matching becomes more efficient and productive.

As described above, user 108 can be both a recipient of promotional offers and a social seller. In some instances, a particular user 108 will elect to exclude himself from one aspect of system 100 or another. For example, one user 108 may decline to participate whatsoever in social selling, while another user 108 may elect to participate exclusively in social selling, declining other promotional offers. One particular advantage of system 100 is the flexibility to allow a user 108 to opt-in to promotional offers and/or social selling opportunities precisely to the extent that user 108 desires.

Additionally, system 100 can be configured to allow for increased flexibility for merchants to promote particular PSE offers. As described in more detail below, the PSE offers are highly customizable to improve the quality and flexibility of social sales. For example, in one embodiment, SSS/H 130 can be configured to allow a merchant 118 to organize a “fast-reaction” social selling opportunity. For example, a restaurant owner may notice that his restaurant is empty and can log on to SSS/H 130 to create a special PSE offer, which is then distributed automatically to pre-determined social sellers who request to be notified of such events. The social sellers can then focus their efforts on promoting that particular restaurant, with compensation adjusted upwards in accordance with similarly pre-determined terms. As such, both merchants and social sellers can respond more quickly to business opportunities as they arise in real-time.

Further, in the above description, user 108 has generally been described from the perspective of an individual operating in a personal capacity. That is, user 108 is often a freelance individual, who does not ordinarily recommend products/services as part of his/her daily work. System 100 can also be configured to allow user 108 to operate in a semi-professional capacity, or otherwise as an aspect of a separate employment. For example, there are many careers and jobs wherein PSE recommendations naturally, and frequently, occur. Hotel concierges, for example, are often asked for restaurant recommendations. Similarly, secretaries, personal assistants, and receptionists are often asked to arrange business meetings centered around a meal, including transportation to and from a restaurant. As described in more detail below, system 100 can be configured to accommodate the particular social selling habits of these semi-professional social sellers, compensating them for their recommendations. For example, in one embodiment, a user 108 can request a reservation at a particular restaurant, with the transaction tracked and recorded to that social seller through SSS/H 130.

As described above, the social selling system embodied in system 100 is illustrated in the context of a general-purpose information and promotional offer system such as, for example, as described in co-pending U.S. application Ser. No. 11/339,893, which is incorporated by reference herein. One skilled in the art will understand that the social selling system described herein can also be implemented independently of the illustrated general information and promotional offer system. For example, in a simplified system, one or more selected features of a general information and promotional offer system can be omitted, as one skilled in the art will understand. Thus, in one embodiment, CMS 102 and SSS/H 130 can be merged into a single server, omitting functionality of CMS 102 that is unrelated to social selling. In an alternate embodiment, SSS/H 130 can be configured as an add-on module to an existing information and promotional offer distribution system, providing the social selling. functionality described herein.

Further, in one embodiment, information related to a particular social selling network can be stored on a social selling server 130. In one embodiment, a particular server or group of servers that contain information grouped into a geographical area is a social selling hub. As such, the embodiment illustrated in FIG. 1 depicts a social selling server/hub 130. In one embodiment, a social selling hub can couple to another social selling hub. For example, a social selling hub that operates within a particular city can share information with a social selling hub that operates with, for example, an entire state. One skilled in the art will understand that other configurations can also be employed.

For example, in one embodiment, SSS/H 130 can be configured as a single server or group of servers that include information that covers a particular city, that is, wherein the users 108 and merchants 118 primarily operate in the given city or metropolitan area. In another embodiment, SSS/H 130 can be configured as a social selling hub with varying relationships between itself and other SSS/H 130 modules, such as, for example, a peer configuration, a master/servant orientation, a ring topography with other social selling servers and/or hubs, and/or other suitable configurations. One skilled in the art will understand that many configurations are suitable depending on the particular needs of the users involved.

Referring now to FIG. 2, the reference numeral 200 generally designates a social selling and information distribution system in accordance with one embodiment of the present invention. Generally, system 200 illustrates a variety of mechanisms through which user 108 can interact with CMS 102. For ease of illustration, user interaction with the social selling system is described in the context of interaction with CMS 102. In a preferred embodiment, a user also interacts with a social selling server/hub (SSS/H), as described above, through CMS 102. One skilled in the art will understand that the SSS/H can be configured as an internal module of CMS 102, a separate module accessed through CMS 102 as a gateway, an add-on independent module sharing some or all information with CMS 102, and/or other suitable configurations.

As described above, user 108 can interact with CMS 102 through mobile device 120 coupled to an IVS 210. In one embodiment, mobile device 120 is coupled to a Global Positioning System transponder and CMS 102 is configured to receive Global Positioning information from mobile device 120. Additionally, user 108 can interact with CMS 102 through a system website 220 through a user interface 106. As used herein, a system website is a website hosted on CMS 102 and configured to provide user 108 with a variety of information input and output mechanisms, especially for user 108 to provide user information and preferences.

In one embodiment, a system website 220 includes a website affiliated with a primary management website. For example, in one embodiment, the primary management website is cityphone.com and a secondary system website is mymobileoffers.com. So configured, some of the functionality of the primary management website can be shifted to the secondary system website. For example, in one embodiment, referred to as “Merchant Connect™”, one subset of mobile offers are shifted to mymobileoffers.com, wherein a user can select from among a number of specific merchants from whom the user would like to receive mobile offers. So configured, mymobileoffers.com allows users to specify those merchants who are permitted to present mobile offers to the user's mobile device, while blocking mobile offers from unselected merchants from the system websites. In a preferred embodiment, Merchant Connect™ employs 1-click technology as described herein.

User 108 can also interact indirectly with CMS 102 through a non-system website 222 through user interface 106. Generally, as used herein, a non-system website is a website hosting a banner ad or other clickable presentation or offer that is coupled to CMS 102. User 108 can click on the offer and the non-system website interacts with CMS 102 to identify the terms of the offer and the user's preferred delivery method, including any referral information. In a social selling context, one skilled in the art will understand that not all of the non-system website offers will correspond with social selling PSE offers. In such cases, the user 108 can be directed to system website 220 to review current social selling PSE opportunities. In an alternate embodiment, where there is no social selling PSE offer corresponding to the non-system website offer, the system 200 can respond completely independently of the social selling network.

Further, in one embodiment, the non-system website is an Internet search website configured to support sponsored or otherwise highlighted search results. In a particular embodiment, the non-system website is configured to receive customized search results for subsequent presentation to those users who perform a search using certain predefined search terms. For example, the non-system website can be configured to present a merchant seafood restaurant PSE offer whenever a user searches for “fish” or “seafood” restaurants, but not when a user searches for “pizza” or “Italian” restaurants. Additionally, in a preferred embodiment, the non-system website “sponsored results” comprise advertisements/offers constructed by CMS 102 and forwarded to the non-system website in advance of actual search requests by users. In an alternate embodiment, the non-system website can also be configured to construct suitable PSE offers in a manner similar to that embodied and described herein, on behalf of CMS 102 and/or SSS/H 130. One skilled in the art will understand that other configurations can also be employed.

User 108 can also interact with CMS 102 to receive requested offers or other information through email system 110 through an email interface 111, as described above. Further, user 108 can interact with CMS 102 through received SMS-text messages through messaging services 230 and mobile device 120. As described above, messaging services 230 can include MMS services, mobile email delivery, next generation messaging services and/or other suitable services.

In the social selling context, the messaging services 230 can be configured in a variety of ways depending on whether user 108 intends to participate in the offer himself, or whether user 108 requests an offer in order to pass along the offer to a member of the FF&PG in a social selling transaction. In one embodiment, interface 106 can be configured to a default self-use orientation or a default promotional-use orientation. That is, so configured, interface 106 interacts with CMS 102 in such a manner that CMS 102 is automatically informed whether user 108 intends to use the requested electronic coupons and other offer indicia himself, or whether the requested information, coupons, or other offer indicia is intended for a FF&PG member in a social selling transaction. One skilled in the art will understand that there are a variety of systems and/or methods through which this information can be passed to CMS 102, including “cookies”, bit settings, user profile default selections, and/or other suitable means.

Generally, the requested offer coupons, for example, include embedded tracking information as described in more detail below. In a self-use orientation, the embedded tracking information can be configured to credit user 108 with his participation in a promotional offer. As such, in one embodiment, a customer loyalty program can also be implemented and/or managed through the social information and promotional offer distribution systems described herein. Accordingly, a merchant 118 can configure certain promotional offers with tiered terms, based on a history or other tracking information that indicates that a particular user 108 is a frequent participant in the promotional offers of the particular merchant 118.

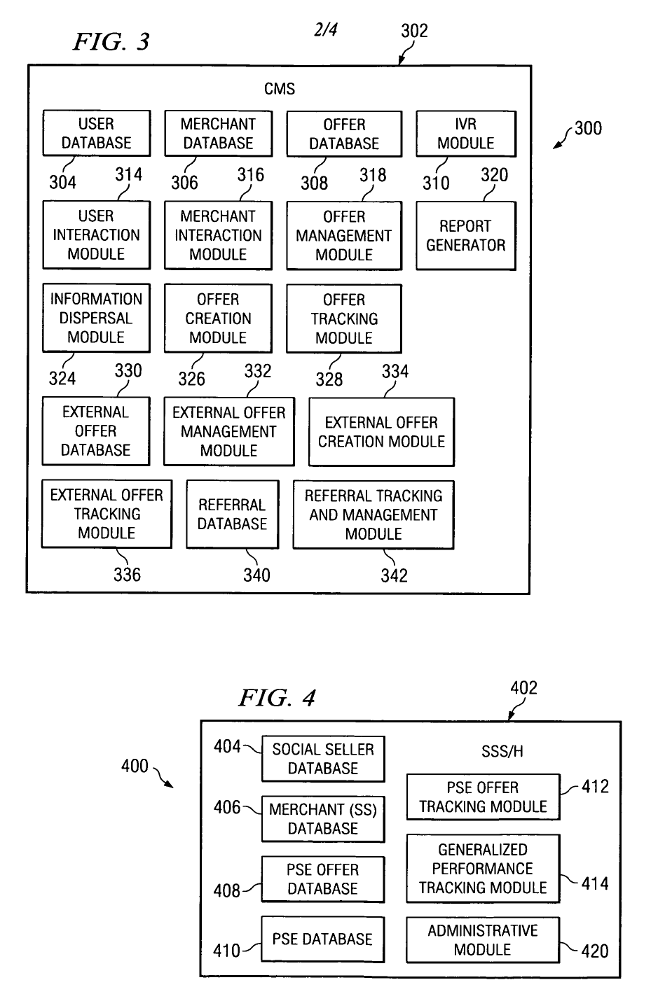

For example, the social information and promotional offer distribution embodiments described herein can be configured with considerable detail regarding interactions between a merchant 118 and a user 108. While specific implementations are described below with respect to FIGS. 3 and 4, general implementations support a wide range of customer-centered service. In one embodiment, for example, a merchant 118 restaurant can track a particular user 108's spending habits within the restaurant that allows the merchant 118 to market more specifically to that user 108.

For example, merchant 118 can restrict certain promotional offers to those users 108 who have spent a certain minimum amount of money in the restaurant within a certain recent time period. In a simple embodiment, the merchant 118 can track which users 108 have ever accepted a promotional offer established by merchant 118 and provide preferred seating to those users 108. In another embodiment, a merchant 118 can offer “VIP” status to those users 108 who meet certain minimum requirements, such as, for example, minimum spending, or number of visits.

In one embodiment, merchant 118 can track user 108 habits internally, employing data and/or reports generated by CMS 102 and/or SSS/H 130 of FIG. 1. In an alternate embodiment, merchant 118 can provide customizable tracking criteria to CMS 102/SSS/H 130, with the content management system and/or social selling server/hub alerting the merchant 118 only when a particular user 108 achieves the pre-determined status. In still another embodiment, the system can be configured such that only transactions originating through a system website are counted towards a user 108's customer rewards status. That is, visits and/or spending at a merchant 118 location that does not originate within the social information and promotional offer distribution system, for example, through at least a reservation request, are not applied to a user 108's profile and/or tracking data and therefore do not increment the user 108's status.

Other customer loyalty rewards configurations are also supported. Additionally, in one embodiment, organizational fundraising can be managed, tracked, and encouraged through the social information and promotional offer distribution embodiments described herein. For example, a particular merchant 118 can elect to establish a fundraising offer wherein a portion of the proceeds of a particular sale or other type of transaction are routed to a promoted organization, such as, for example, a church, local civic organization, or other charitable organization. So configured, a “fundraising offer” is a variation of a “promotional offer”, wherein some or all of the benefits of the transaction are routed to a third party instead of the merchant 118 that established the offer. Additionally, the social information and promotional offer distribution system can be configured to track tax-related information regarding charitable contributions and/or summary data for corporate sponsorship recognition. Accordingly, customer loyalty tracking and promotion can be entirely automated from the perspective of the merchant 118. Further, one skilled in the art will understand that the social information and promotional offer distribution embodiments described herein therefore support a wide variety of novel marketing and social selling configurations.

As described above, the particular offer indicia can also be configured from a promotional-use orientation. In a promotional-use orientation, for example, the embedded tracking information can be configured to credit user 108, as a social seller, for his influence in a subsequent purchase made with the requested coupon. As such, the requested coupons can be configured as forwardable or non-forwardable, depending on whether the requested coupon is for self-use or promotional-use. Generally, in certain situations, a merchant 118 may wish to restrict the number of accepted promotional offers, such as, for example, when providing discounted meals. In other situations, a merchant 118 may not wish to restrict the number of accepted offers, such as, for example, when the merchant 118 is selling mass-produced merchandise at a profit.

Accordingly, the social information and promotional offer distribution system can be configured to subtly encourage or discourage multiple use of certain requested coupons. For example, where a promotional offer coupon is received as a non-forwardable SMS message, generally only the owner of the mobile device that receives the non-forwardable SMS message (i.e., that specific user 108) can effectively use the promotional coupon. Where a promotional offer (e.g., a promotional PSE offer) is received as an electronic mail message with a referral link for an online transaction, the user 108 who requested the promotional offer can easily forward the electronic mail message to multiple members of his FF&PG. As such, the format of the requested promotional offer coupon can be configured to support or disable undesirable consumer behavior.

Additionally, as described above, system 200 is configured to allow user 108 to interact with CMS 102 through IVS 210. In one embodiment, the interactive voice response system is based on CallXML technology. In an alternate embodiment, IVS 210 can be configured to support VoiceXML. In an alternate embodiment, IVS 210 can be configured to support text-to-speech and/or voice synthesis.

In a particular embodiment, IVS 210 is configured with an artificial intelligence known as “David.” David is configured to access, retrieve, and synthesize information collected from the various merchant, social seller, user, and promotional offer databases. Generally, in embodiments of IVS 210 configured with David, IVS 210 interacts with a user 108 in a voice-recognition mode. In voice recognition mode, user 108 can ask questions of and receive answers from IVS 210 related to the user account, and/or products/services promoted through the social information and promotional offer distribution and management system.

IVS 210/David can also be configured to recognize spoken access passwords, numbers, voice signatures, and/or other suitable security measures. In response to a valid security check, IVS 210/David can be configured to retrieve information from, for example, a user database, and offer recommendations and/or suitable promotional offers based on a prior user history. For example, in an instance where a user 108 accessed the system from Houston, Tex., requested information on Italian restaurants, and received a coupon for opera tickets, IVS 210/David can be configured to prompt the user 108 to determine whether the same search criteria should also be used when user 108 calls from, for example, New York City. Alternately, IVS 210/David can be configured to search for promotional offers related to opera tickets whenever user 108 requests information on Italian restaurants.

As described above, mobile device 120 can also be coupled to the international Global Positioning System (GPS). So configured user 108 can also provide geographical preference information to SSS/H 130 and/or CMS 102. For example, a user 108 driving past a restaurant or shopping mall that interests the user 108 can indicate the geographical location to SSS/H 130 and/or CMS 102. Subsequent offers and/or merchants located near (or within a certain radius of) that location can be highlighted for the user 108. In one embodiment, a geographical location specified by the user 108 can be employed as a “preferred” location, such as a downtown arts district or farmer's market, for example. Subsequent offers can also be marked with a distance from the user 108 preferred location point. One skilled in the art will understand that other configurations can also be employed.

One skilled in the art will understand that the particular matching criteria can be varied and can develop over time based on additional choices and selections made by user 108 over a period of time. As such, in one embodiment, the social information and promotional offer distribution and management systems and methods described herein can be not only highly customizable, but also adaptive to actual user preferences as disclosed over time. Additional features will also be apparent to one skilled in the art in light of the additional disclosure below.

Referring now to FIG. 3, the reference numeral 300 generally designates a content management system in accordance with one embodiment of the present invention. As described above, the features of the content management system described herein are illustrated in the context of a system with a compartmentalized social selling server/hub. One skilled in the art will understand that one or more of the depicted features can also be included in a social selling server/hub in other embodiments.

As illustrated, system 300 includes CMS 302. In one embodiment, CMS 302 is configured as CMS 102 of FIG. 1, above. In the illustrated embodiment, CMS 302 includes a variety of modules. In particular, CMS 302 includes user database 304, merchant database 306, and offer database 308.

Generally, user database 308 is configured to receive and store user information. Similarly, merchant database 306 is configured to receive and store merchant information and offer database 308 is configured to receive and store promotional offer information. In one embodiment, to address privacy concerns, merchants cannot access user database 304. Instead, offer creation module 326 automatically assesses which users get which offers, and the users remain anonymous to the merchants. Similarly, some merchants do not want every user to know what and how they are advertising. Accordingly, in one embodiment, users cannot access merchant database 306. Instead, the users only see those offers for which they have been selected (either through their criteria, or the merchant's criteria).

CMS 302 also includes an IVR module 310 configured to support an IVR system to interact with a user and to retrieve user information and user communications for forwarding on to other modules. As described above, IVR 310 can be configured to support voice synthesis and/or artificial intelligence such as, for example, the “David” system.

CMS 302 also includes user interaction module 314 and merchant interaction module 316. Generally, user interaction module 314 is configured to interact with a user to receive user information for forwarding to user database 304. Similarly, merchant interaction module 316 is configured to interact with a merchant to receive merchant information for forwarding to merchant database 306. CMS 302 also includes offer management module 318. Generally, offer management module 318 is configured to receive offer information from a merchant and to manage offer information through interaction with offer database 308.

CMS 302 also includes information dispersal module 324. Generally, information dispersal module 324 is configured to receive requests for information from a user through user interaction module 314, to collect requested information from merchant database 306, and to forward requested information to the user. As described above, only certain merchant information is available to users, such as, for example, merchant contact information, directions to the merchant's place of business, and other suitable information.

CMS 302 also includes offer creation module 326 and offer tracking module 328. Generally, offer creation module 326 is configured to retrieve requested offer information from offer database 308, to retrieve an offer tracking code from offer tracking module 328, to embed a retrieved offer tracking code into an offer coupon, and to transmit the offer coupon to the user. In an alternate embodiment, offer creation module 326 is further configured to retrieve a referral code from referral tracking and management module 342 and to embed a retrieved referral code into the offer coupon.

Generally, offer tracking module 328 is configured to generate a unique tracking code for each offer and each coupon associated with an offer and to forward the unique tracking code to offer creation module 326. In an alternate embodiment, offer tracking module 328 is further configured to retrieve a referral code from referral tracking and management module 342 and to incorporate the referral code into the tracking code. In an alternate embodiment, offer tracking module 328 is configured to generate a bar code embodying the tracking code.

CMS 302 also includes a report generator 320. Generally report generator 320 is configured to retrieve information from one or more modules of CMS 302 and to generate reports based on retrieved information.

CMS 302 also includes external offer database 330, external offer management module 332, external offer creation module 334, and external offer tracking module 336. Generally, external offers are offers generated through non-system websites. Generally, external offer database 330 is configured to receive and store external offer information. Generally, together, external offer database 330, external offer management module 332, external offer creation module 334, and external offer tracking module 336 perform similar tasks as their offer counterparts. For example, external offer management module 332 performs similar tasks as offer management module 318, and so forth.

CMS 302 also includes referral database 340 and referral tracking and management module 342. Generally, referral database 340 and referral tracking and management module 342 perform similar tasks s their offer counterparts, with respect to referral information. For example, in one embodiment, referral tracking and management module 342 is configured to generate a unique referral code based on referral information from referral database 340 and to track referral codes used in redeemed coupons.

Thus, generally, the above systems operate as follows in an example, non-limiting embodiment. There is an interface that can be used by any web application to query for available coupons, reserve them, send them via text message, or un-reserve them to be made available again. The interface controls access to the SMS gateway.

The interface is responsible for taking the establishment code requested (a unique merchant identification code) and pulling the following information from the databases in order to generate message text to be displayed by the requesting application to the user, or to be included in a outgoing text message. The text coupon can include, for example, a) The coupon identifier/tracking code; b) the Establishment name; c) the item(s) being discounted; d) the promotional offer expiration date; e) sponsorship information (e.g., “Sponsored by [Merchant]”) and/or f) any conditions that must be met in order to redeem the promotional offer coupon.

In addition to tracking that information for each coupon, the CMS also tracks the promotion start date, the date the coupon was reserved, and the date the coupon was sent through the SMS gateway. The promotion start date is used in conjunction with the reservation date to determine if the coupon is available. If the request date is greater than the start date and the coupon has never been previously reserved, then the coupon is available.

The interface will mark the coupon as reserved after it has been requested. A separate request for the web application initiates the actual SMS text message. That request specifies the cell phone number, the coupon code, and the text message to send. In an alternate embodiment, the interface does not require an application to provide the text message to send. Once the coupon has been sent as a text message, the interface marks the SMS sent date in the offer database.

Further, in an alternate embodiment, the various system components include a promotional offer coupon management subsystem. A front end GUI allows (merchant or administrative) users to load coupons into the system. This GUI allows users to define promotion types (what items are being promoted), restriction types (conditions to meet in order to redeem), promotion start dates, expiration dates, coupon identifiers and other suitable information. A coupon number generator creates the tracking code, which can include a referral code, and allows users to choose from drop-down GUI menus what the discount will be for and what restrictions will be in place. A reporting module and/or GUI tracks coupons by one of many variables, including establishment date, redemption information and other suitable variables.

As described above, in a particular embodiment, one or more of user interface 124 and/or merchant interface 114 can be configured as a GUI, and this GUI can comprise a “Mobile Offer Management (MOM)” module. In one embodiment, the MOM/GUI can be configured with a merchant—[ed: the hyphen here is intentional] or a social seller-orientation. When configured with a merchant-orientation, for example, the MOM/GUI can be employed to perform the various tasks described herein attributable primarily to the merchant and/or system administrators, such as, for example, to allow a merchant to create and manage a coupon inventory, manage particular users and/or groups, and control the frequency of coupon “pushes” or transmission of special PSE offers. In a particular embodiment, the merchant-oriented MOM/GUI is configured to accept payments, such as, for example, through online banking transfers, or other suitable electronic payment systems. In a preferred embodiment, the merchant-oriented MOM/GUI is configured to accept Citycash™ payments. One skilled in the art will understand that other configurations can also be employed.

When configured with a social seller-orientation, for example, the MOM/GUI can be employed to perform the various tasks described herein attributable primarily to a social seller/user and/or system administrator, such as, for example, to allow a social seller to create customized referral messages, to modify merchant-created PSE promotional offer formats/layouts, to manage FF&PG contact and preference information, to control the frequency of reminder messages and/or offers, and to review and attach to one or more PSE promotional offers. In a particular embodiment, the social seller-oriented MOM/GUI is configured to make payments, such as, for example, through online banking transfers, or other suitable electronic payment systems. In a preferred embodiment, the social seller-oriented MOM/GUI is configured to make Citycash™ payments. One skilled in the art will understand that other configurations can also be employed.

One skilled in the art will understand that the particular functions embodied in a MOM/GUI, whether merchant- or social seller-oriented, can be further customized to meet the desires and/or requirements of the particular social selling network the system is employed to support. Accordingly, some functionality in a merchant-oriented MOM/GUI can be ported to a social seller-oriented MOM/GUI, and vice-versa, and certain functionality can be omitted and/or added without departing from the scope of the present invention.

Thus, CMS 302 can be configured to support a separate information and promotional offer management and distribution system in addition to the social selling systems and methods also described herein. For ease of illustration, these functions and modules have been described independently in order not to obscure the unique and novel aspects of either system embodied herein. One skilled in the art will understand that one or more modules of one system can be advantageously combined with one or more modules of the other system. For example, in a preferred embodiment CMS 102 can be configured to store the user database, while SSS/H 130 is configured to store the social seller database and the social selling PSE offer database. So configured, SSS/H 130 can extract general user information about a social seller from the user database of CMS 102 and social selling history for the social seller from the social seller database, employing both the user information and the social selling history to evaluate whether a social seller qualifies to attach to a particular social selling PSE offer.

Referring now to FIG. 4, the reference numeral 400 generally designates a social selling server/hub in accordance with one embodiment of the present invention. As described above, the features of the social selling server/hub described herein are illustrated in the context of a system with a compartmentalized social selling server/hub. One skilled in the art will understand that one or more of the depicted features can also be included in a content management system in other embodiments.

As illustrated, system 400 includes social selling server/hub (SSS/H) 402. In one embodiment, SSS/H 402 is configured as SSS/H 130 of FIG. 1, above. In the illustrated embodiment, SSS/H 402 includes a variety of modules. In particular, SSS/H 402 includes social seller database 404, merchant database 406, and PSE offer database 408.

Generally, social seller database 408 is configured to receive and store social seller information. Similarly, merchant database 406 is configured to receive and store merchant social selling information and PSE offer database 408 is configured to receive and store promotional PSE offer information. Additionally, PSE database 410 is configured to receive and store PSE information. Generally, social seller information includes user information for a social seller, as well as other suitable information, such as, for example, a social selling history for the social seller, social selling preferences, indicia indicating what particular PSE the social seller owns or otherwise has purchased, and/or other suitable information.

Generally, merchant social selling information includes general merchant information, as well as other information, such as, for example, a product history for the merchant, a social selling PSE offer history, indicia indicating what particular PSE the merchant has promoted through social selling, default PSE offer terms and conditions, default social seller qualifying requirements, and/or other suitable information. Generally, promotional PSE offer information includes the terms and conditions of the PSE offer, social seller qualifying requirements, tiered terms, if applicable, and/or other suitable information. Generally PSE information includes product, service, or entertainment descriptive information related to the PSE and independent of any particular offer. Thus, generally, promotional PSE offer information relates to the offer, while PSE information relates to the PSE itself. One skilled in the art will understand that other configurations can also be employed.

In one embodiment, similar to a like configuration of CMS 102, to address privacy concerns, merchants cannot access social seller database 404. Instead, administrative module 420, described in more detail below, automatically assesses which social sellers qualify for which PSE offers, and the social sellers remain anonymous to the merchants. Similarly, some merchants do not want every social seller to know what and how they are advertising. Accordingly, in one embodiment, social sellers cannot access merchant database 406. Instead, the social sellers only see those PSE offers for which they have been selected or otherwise qualify (either through the social seller's criteria, or the merchant's qualifying requirements).

SSS/H 402 also includes an administrative module 420. Administrative module 420 is configured to interact with CMS 102, for example, and to allow access to one or more databases of SSS/H 402 by social sellers and/or merchants, or administrators, and to generally coordinate the interactions of the various components of SSS/H 402. Thus, for example, administrative module 420 can also be configured to perform functions similar to some or all of the functions of offer management module 318, information dispersal module 324, offer creation module 326, report generator 320, and/or referral tracking and management module 342, of FIG. 3, for example.

In the illustrated embodiment, SSS/H 402 also includes PSE offer tracking module 412 and generalized performance tracking module 414. Generally, PSE offer tracking module 412 is configured to receive and store information regarding pending and completed PSE offers, grouped by, for example, PSE or merchant. PSE offer tracking module 412 can also be configured to interact with administrative module 420 to forward information for administrative module 420 to update the social seller database 404, the merchant database 406, and the PSE offer database 408, for example.

In the illustrated embodiment, generalized performance tracking module 414 is configured to access the social seller database 404 and the PSE offer database 408 and to retrieve generalized information relating to social sellers and PSE offers. Generalized performance tracking module 414 is configured to perform a variety of global tracking tasks. For example, assimilated data for all (or at least more than one) social sellers and/or PSE offers is often useful to determine whether the social selling system itself is operating at a desired efficiency, whether certain groups of social sellers are struggling, to support trend analysis of which PSE is the most popular and which PSE offer are the most/least popular among the social sellers and/or the FF&PGs, whether certain geographical regions are less productive than other geographical regions, whether certain referral chains of social sellers are less productive than other referral chains, and/or various other tracking and performance information. One skilled in the art will understand that accumulated general social selling data can be employed to generate a wide variety of perspectives, which can support important business decisions. Accordingly, social selling server/hub 402 can be employed to encourage and manage social selling in a wide variety of ways.

Thus, generally, the above systems operate as follows in an example, non-limiting embodiment. The following example will be described in the context of SSS/H 402, for ease of illustration. First, a merchant establishes a merchant account, with merchant information stored in merchant database 406. Next, the merchant establishes a PSE offer, with PSE offer information stored in PSE offer database 408. PSE information related to the particular PSE of the PSE offer is stored in PSE database 410. Next, a user establishes a social seller account, with information stored in social seller database 404.

Administrative console 420 searches the existing PSE offers in PSE offer database 408 and determines which PSE offers the social seller qualifies for, based on the PSE offer information and the social seller information. The social seller is presented with one or more suitable PSE offers, and selects a particular PSE offer to “attach” to, thereby agreeing to the terms and conditions of that PSE offer.

Next, the social seller promotes the PSE, in the context of the PSE offer, to the social sellers FF&PG. At some point, the social seller requests a promotional offer indicia to pass to a FF&PG member who has agreed to purchase the PSE. The promotional offer indicia can be generated and transmitted to the social seller by administrative module 420, or through interaction with CMS 102. The social seller passes the received promotional offer indicia to the FF&PG member, who employs the promotional offer indicia to purchase the promoted PSE, by presenting the promotional offer indicia to the merchant that established the PSE offer.

The merchant receives the promotional offer indicia, makes the sale, and forwards the completed transaction information to SSS/H 402 (as described above in the context of CMS 302, for example). Administrative module 420 receives the completed transaction information and updates the social seller database 404, the merchant database 406, the PSE offer database 408, and/or the PSE database 410, as appropriate. Depending on the terms of the PSE offer, the social seller is subsequently compensated for his influence in the social sale. Thus, as described above, a social selling transaction can be initiated, organized, encouraged, tracked, and finalized in a manner superior to previous methods and systems.

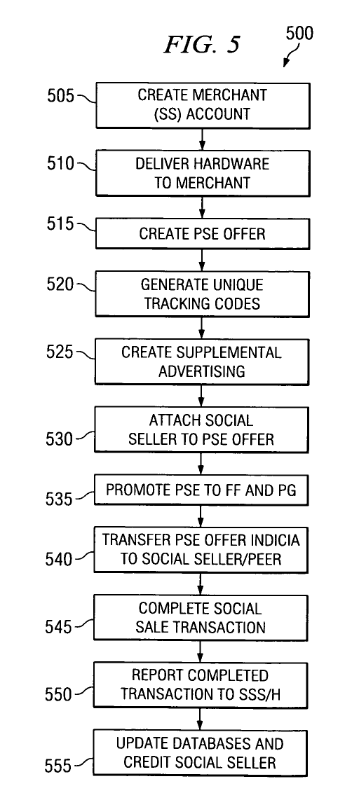

Referring now to FIG. 5, the reference numeral 500 generally designates a social information and promotional offer distribution and management method in accordance with one embodiment of the present invention.

Generally, the details of the method can be described with respect to various points of a peer-initiated social selling engagement from the point where a merchant creates an account to the time when the databases are updated and the social seller's account is credited. Thus, the method described in FIG. 5 generally depicts a peer initiated social selling engagement that is tracked through one or more databases and reconciled through, for example, tracking codes and referral codes that are contained in electronic mail messages and/or text messages.

The process begins at step 505, wherein a merchant creates a social selling account on a social selling server of a social selling hub. This step can be performed by, for example, merchant 118 creating a merchant social selling account on SSS/H 130 of FIG. 1. This step can include providing bank details, verifying agreement to social selling server operator terms and conditions, assignment of a unique merchant identification code, and/or establishing merchant administrative access to the content management system and/or social selling server. In an alternate embodiment, the merchant can submit a completed paper form to the social selling hub maintainer/owner, who will subsequently set up the merchant's social selling account on the system.

At next step 510, applicable hardware is delivered to the merchant. As described above, in one embodiment, a merchant can report completed social sales to the social selling server/hub through employment of a stand-along or otherwise POS device. Thus, this step can include sending a point-of-sale scanner to the physical location of a retail establishment, for example.

At next step 515, the merchant creates a specific PSE offer. This step can be performed by, for example, merchant 118 creating a PSE offer on SSS/H 130 of FIG. 1. This step can include providing the details of the PSE offer, including the particular PSE, the offer redemption terms, the qualifying social seller information, and/or the social selling payment to the social sellers who participate. For example, in one embodiment, the merchant can designate, through the PSE offer information, that only female social sellers are acceptable, or only social sellers within a particular age range qualify to promote the PSE offer.

At next step 520, various unique tracking and referral codes are generated. This step can be performed by, for example, SSS/H 130 of FIG. 1. Generally, this step can include tracking and/or referral codes generated as part of a general information and promotional offer distribution and management system, or can be generated especially for the particular PSE offer. In one embodiment, the unique tracking code can be either a pure referral code, internally tied to a social seller or the merchant. In an alternate embodiment, the unique tracking code can be a separate code, employed solely for that particular PSE/merchant combination. In an alternate embodiment, the unique tracking code is a unique PSE offer code and is a function of the merchant ID, the offer ID, and an attached the social seller ID (from step 530 below).

One skilled in the art will understand that the unique tracking code can be configured in a variety of other suitable manners. For example, in one embodiment, (web) referrals that visit a PSE-related website are tied to a particular referrer (who is also a social seller), and subsequent visits to the website assume that the social seller is the same social seller influencing the referral. In an alternate embodiment, the social seller receives whatever banners, coupons, etc. are employed to promote the PSE electronically, and therefore the social seller distributes the banners, coupons, etc.

In one embodiment, the codes generated in step 520 are based on the merchant ID and the offer ID, and the codes serve as general referral/tracking codes. Thus, in one embodiment, the general referral/tracking codes can serve to track both sales that have no particular social seller associated with the sale, and sales that come through or are otherwise initiated by the social selling hub. Thus, the merchant can still track social sales, even when the specific social seller is not identified. Further, as described above, the unique codes can be embedded in email links, text message (e.g., SMS) links, bar codes and other suitable encoding means.

At next step 525, social selling server/hub establishes supplemental advertising. In one embodiment, supplemental advertising includes reviews, images, and links on a central website. In an alternate embodiment, custom advertisements are also distributed to one or more websites throughout the Internet. The appropriate tracking and/or referral code is embedded by the social selling server/hub. Generally, supplemental advertising can include SMS coupon generation as performed by a general information and promotional offer management and distribution system independent from the illustrated social information and promotional offer management and distribution embodiments described herein.

Further, in one embodiment, supplemental advertising can include an Internet search website configured to support sponsored or otherwise highlighted search results. In a particular embodiment, the Internet search website is configured to present customized search results to those users who perform a search using certain predefined search terms. For example, the search website can be configured to present a merchant seafood restaurant PSE offer whenever a user searches for “fish” or “seafood” restaurants, but not when a user searches for “pizza” or “Italian” restaurants. Additionally, in a preferred embodiment, the search website “sponsored results” comprise fully compatible PSE promotional offers constructed by CMS 102 and/or SSS/H 130. In an alternate embodiment, the search website can be configured as a non-system website and enabled to construct suitable PSE offers in a manner similar to that embodied and described herein, on behalf of CMS 102 and/or SSS/H 130. One skilled in the art will understand that other configurations can also be employed.

At next step 530, a social seller is presented with the PSE offer and elects to attach to the PSE offer. This step can be performed by, for example, user 108 interacting with SSS/H 130 of FIG. 1. This step can include a determination whether the social seller qualifies for the PSE offer. Thus, in one embodiment, this step can include the social selling server comparing the social seller's “social seller rating” (or “SSR,” described in more detail below) with the merchant's designated minimum SSR are described in the PSE offer information.

Additionally, this step can include generating various unique offer codes that associate the social seller with the PSE offer. As described above with respect to step 520, the social selling server/hub can generate both a general tracking code and a plurality of specific codes that designate a particular social seller as influencing the sale. Thus, in one embodiment, the merchant remains unaware who the specific social sellers are that promote the PSE offer. That is, in one embodiment, the qualification assessment is performed anonymously and automatically by the social selling server/hub.

At next step 535, the social seller promotes the PSE to the social seller's friends, family, and peer group (FF&PG). In one embodiment, this step includes the social seller talking up, demonstrating, promoting, or otherwise influencing one or more people in the social seller's FF&PG to purchase the PSE.

At next step 540, PSE offer indicia are transferred to the social seller and/or a member of the social seller's FF&PG. This step can be performed by, for example, SSS/H 130 and gateway 112, gateway 122, and/or user interface 106 of FIG. 1. In one embodiment, on request from a peer, the social seller requests the SSS/H to send an electronic coupon with an embedded unique tracking code to the peer. In an alternate embodiment, the social seller requests the SSS/H to send a text message with an embedded unique tracking code to the social seller's mobile device.

Thus, this step includes generating PSE offer indicia, which can include a text message and/or an electronic mail message, which contains tracking codes, referral codes, bar codes, and/or some other means of tracking the purchase to tie the social seller's influence into the purchase. Generally, the embedded unique tracking code is the unique tracking code generated in step 530 and/or 530. In one embodiment, the PSE offer indicia contains details that are needed to complete and track the purchase and reconcile the user, the social seller, and the merchant databases.

At next step 545, the social sale transaction is completed. Generally, this step includes the member of the social seller's FF&PG presenting the PSE offer indicia to the merchant and purchasing the PSE according to the PSE offer.

At next step 550, the completed transaction is reported to the social selling server/hub. As described above, in one embodiment, a bar code embedded within a text message is read by a POS scanner, which transmits the recorded information to the social selling server/hub. In an alternate embodiment, such as, for example, in the case of an online PSE transaction, an electronic mail message link, which includes reconciliation and tracking details is used to initiate the PSE purchase and a copy of the transaction record is forwarded to the social selling server/hub. In an alternate embodiment, the merchant sends paper copies to the social selling server/hub operator, who subsequently enters the received information into the social selling server.

At next step 555, the databases and/or other accounts related to the PSE offer transaction are updated. This step can be performed by, for example, SSS/H 130 of FIG. 1. This step can include the social selling server/hub crediting the social seller for the sale, updating the social seller database, the merchant database, and the PSE offer database. Thus, this step can also include issuing pre-determined rewards and/or other compensation to the social seller for the social sale influence, in accordance with the PSE offer.

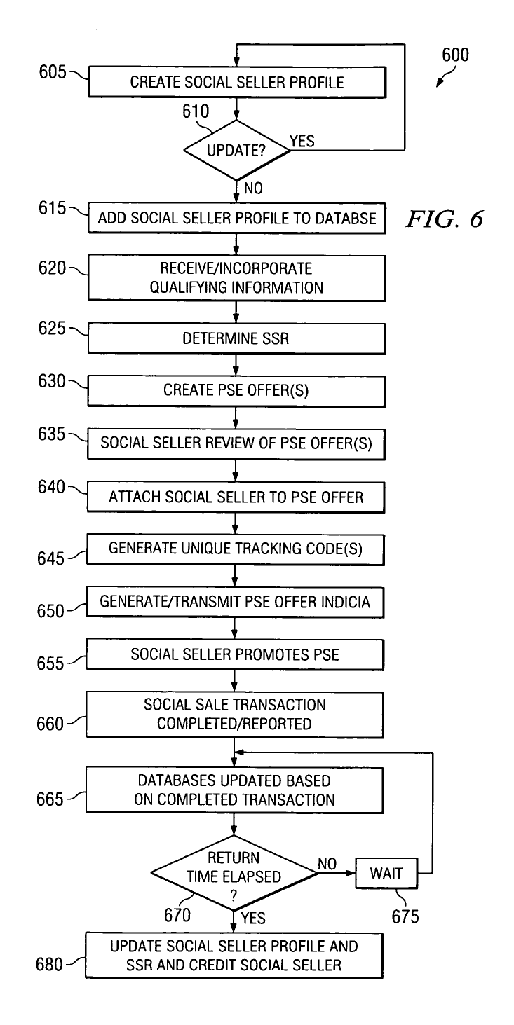

Referring now to FIG. 6, the reference numeral 600 generally designates a flow diagram illustrating the steps of a social information and promotional offer management and distribution method in accordance with one embodiment of the present invention. The process begins at step 605, wherein a user creates a social seller profile on the social selling server/hub. This step can be performed by, for example, user 108 creating a social seller profile on SSS/H 130 of FIG. 1.

At next decisional step 610, a determination is made whether the user desires to update the social seller profile. This step can be performed by, for example, user interaction module 314 of FIG. 3 and/or administrative console 420 of FIG. 4. If at decisional step 610 it is determined that the user desires to update the social seller profile, the process continues along the YES branch and returns to step 605. If at decisional step 610 it is determined that the user does not desire to update the social seller profile, the process continues along the NO branch to step 615. At step 615, the social seller profile is assimilated into a social seller database. This step can be performed by, for example, social seller database 404 of FIG. 4.

At next step 620, the social seller provides qualifying information to the social seller profile. In one embodiment, this step can be incorporated into step 605. In an alternate embodiment, this step can be kept separate or otherwise delayed to allow new users to gradually become comfortable with the idea and mechanics of social selling. In one embodiment, qualifying information includes a variety of socioeconomic and preference information generally employed to distinguish sub-groups of social sellers from other groups of social sellers, and is generally employed by merchants in establishing targeted PSE offers.

For example, in one embodiment, a social seller selects a peer group, wherein age is one of the main distinguishing criteria. Beginning with age, a social seller is asked to select certain criteria based on pre-conceived social norms that ultimately influence purchase decisions. The criteria could include the following, for example:
stay in? or go out?
deals/discount? or VIP treatment and perks?
brand name? or designer knock-offs?
spend? or save?
active/sports? or party?
eat out? or eat in?
latest and greatest technology? or status-quo?
trend setter? or trend follower?
income level
education level
body shape or fitness level
worldliness (as quantified by, for example, the number of foreign countries the social seller has visited)
primary spoken language
gender/sexuality/race
secondary group membership (e.g., Mensa, NRA, Masons, etc.)

One skilled in the art will understand that a wide variety of other qualifying information can also be employed.

At next step 625, the social selling server determines the social seller's “social seller rating” (SSR). Generally, the SSR is itself qualifying information and incorporates one or more of the other qualifying information data points, as well as data relating to the social seller's sales experience and/or social sales history. For example, in one embodiment, a social seller's SSR is incremented if the social seller himself owns or has purchased the PSE promoted in a PSE offer. Thus, in one embodiment, the SSR is a function of a PSE offer.

In an alternate embodiment, the SSR is a function of the number of PSE units the social seller has sold. Thus, the SSR is incremented whenever a SSR successfully influences a social sale and decremented whenever a previously completed social sale transaction is unwound, such as, for example, in the case of a returned PSE. In an alternate embodiment, the SSR is a function of the number of PSE units the social seller has socially sold, the length of calendar time the social seller has been associated with the social selling server/hub, the education level of the social seller, and the sophistication of the particular PSE the social seller has socially sold in the past. One skilled in the art will understand that other configurations can also be employed.

At next step 630, one or more merchants create a PSE offer. Generally, the process of creating a PSE offer is described in more detail above with respect to step 515 of FIG. 5. Thus, generally, this step can include a merchant creating a merchant profile and establishing a promotional PSE offer. This step can be performed by, for example, merchant 118 establishing a merchant profile and establishing a promotional offer on CMS 102 and SSS/H 130 of FIG. 1.

At next step 635, the social seller reviews current PSE offers. As described above, in one embodiment, only those PSE offers for which the social seller qualifies are presented to the social seller for review.

At next step 640, the social seller attaches to a PSE offer. As described above, in one embodiment, this step includes updating the social seller database and the PSE offer database to include linking information connecting the social seller to the PSE offer. In one embodiment, the social seller can be restricted to attaching to only a certain pre-determined maximum number of PSE offers at any one time.

Further, in one embodiment, the social seller profile can include all the PSE offers presented to the social seller, highlighting selected PSE offers, in order to determine social seller preferences between offers. For example, the social selling server can track whether the social seller consistently elects to promote, for example, shoes or audio players when presented with that choice. This preference information can be stored in the social seller profile and/or the generalized performance tracking module and can be used to make subsequent PSE offers more attractive and/or more suitable/enjoyable for the social seller. As such, in one embodiment, this step includes the social selling server updating one or more databases to reflect the social seller's revealed preference information.

At next step 645, unique tracking codes are generated. This step can be performed by, for example, SSS/H 130 of FIG. 1. As described above, the unique tracking codes can be based on the merchant ID, the social seller ID, the PSE offer code, and/or other suitable information.

At next step 650, PSE offer indicia are generated. This step can be performed by, for example, SSS/H 130 of FIG. 1. As described above, the PSE offer indicia can include, for example, SMS/text-messages configured with embedded tracking codes, electronic mail messages configured with embedded tracking codes, and/or other suitable indicia. Further, as described above, the PSE offer indicia can be configured as forwardable, in a promotional-use orientation, or non-forwardable, in a self-use orientation. Generally, this step includes transmitting the generated PSE offer indicia to the social seller in accordance with preference information recorded in the social seller's profile and/or specially-received information obtained from the social seller at the point where the social seller attaches to the PSE offer.

At next step 655, the social seller promotes the PSE and at next step 660, a member of the social seller's FF&PG completes a PSE purchase transaction, employing the PSE offer indicia. At next step 665, the social selling server/hub is notified of the completed transaction (as described above), and updates the relevant databases in response to received completed transaction information.

At next step 670, a determination is made whether a pre-determined return time has elapsed. That is, in one embodiment, for example, the PSE offer information indicates that the social seller is entitled to rewards/compensation only after the return period for the socially influenced sale has elapsed. In such an embodiment, the social selling server/hub is configured to determine whether the pre-determined return time has elapsed, in accordance with the PSE offer information.

If at decisional step 670 a determination is made that the return time has not elapsed, the process continues along the NO branch to step 657, wherein the process “waits,” subsequently returning to step 670. One skilled in the art will understand that “waiting” can include performing other tasks and processes, with a periodic determination as described in step 670. If at decisional step 670 a determination is made that the return time has elapsed, the process continues along the YES branch to step 680.

At next step 680, the social seller's SSR and/or profile are updated to indicate successful completion of a social sale. Further, in one embodiment, this step can include crediting or otherwise compensating the social seller for the socially-influenced sale in accordance with the PSE offer information. In one embodiment, the social seller's SSR and/or profile are updated in step 665, and the compensation alone is delayed until step 680. One skilled in the art will understand that other configurations can also be employed. Thus, a novel social selling method has been disclosed that overcomes the disadvantages of prior systems and methods.

It should be apparent from the foregoing that an invention having significant advantages has been provided. While the invention is shown in only a few of its forms, it is not just limited but is susceptible to various changes and modifications without departing from the spirit thereof.

I claim:

1. A system, comprising:
a merchant database comprising merchant information and organized into merchant accounts by a plurality of unique merchant identifying codes;
a social seller database comprising social seller information and organized into social seller accounts by a plurality of unique social seller identifying codes;
a promotional offer database comprising promotional offer information and organized into promotional offer records by a plurality of unique promotional offer identifying codes;
a social selling server coupled to the merchant database, the social seller database, and the promotional offer database, and configured to link one or more promotional offer records in the promotional offer database with a merchant account in the merchant database;
the social selling server further configured to link a social seller account to a promotional offer record based on the promotional offer record;
the social selling server further configured to provide promotional offer indicia to a social seller associated with a linked social seller account; and
the social selling server further configured to receive completed transaction information for a purchase influenced by the social seller and to update the merchant database, the social seller database, and the promotional offer database based on received completed transaction information.

2. The system of claim 1, wherein the social seller information comprises a social seller rating (SSR).

3. The system of claim 2, wherein the SSR is based on a history of social selling by the social seller.

4. The system of claim 1, wherein the promotional offer information comprises terms, conditions, and qualifying requirements.

5. The system of claim 4, wherein the qualifying requirements are based on a minimum required history of social selling by the social seller.

6. The system of claim 1, wherein the promotional offer indicia comprises a unique referral code and the social selling server is further configured to generate the unique referral code based on a unique merchant identification code, a unique social seller identification code, and a unique promotional offer identification code.

7. The system claim 1, wherein the social selling server is further configured to generate and transmit to the social seller a short message service (SMS) text message comprising the promotional offer indicia and further comprising an embedded unique referral code.

8. The method of claim 1, wherein the social selling server is further configured to generate and transmit to the social seller an electronic mail message comprising the promotional offer indicia and further comprising an embedded unique referral code.

9. A social information and promotional offer distribution and management method, comprising:
establishing a merchant account in electronic form associated with a merchant;
establishing a social seller account in electronic form associated with a social seller;
establishing a promotional offer in electronic form linked to the merchant account;
attaching the social seller account to the promotional offer;
providing indicia of the promotional offer in electronic form to the social seller;
identifying an influenced purchase based on the provided indicia, the influenced purchase a result of promoting by the social seller the promotional offer among a social network associated with the social seller and the social seller transferring the provided indicia;
updating the merchant account based on the influenced purchase; and
updating the social seller account based on the influenced purchase.

10. The method of claim 9, wherein establishing the merchant account comprises:
generating a unique merchant identification code;
receiving merchant information from the merchant; and
storing received merchant information in a database organized by the unique merchant identification code.

11. The method of claim 9, wherein establishing the social seller account comprises:
generating a unique social seller identification code;
receiving social seller information from the social seller; and
storing received social seller information in a database organized by the unique social seller identification code.

12. The method of claim 9, wherein establishing the promotional offer comprises:
generating a unique promotional offer identification code;
generating a unique merchant identification code;
receiving promotional offer terms and conditions from the merchant; and
storing received promotional offer terms and conditions in a database organized by the unique promotional offer identification code and the unique merchant identification code.

13. The method of claim 12, wherein the received terms and conditions include qualifying requirements for social sellers.

14. The method of claim 9, wherein providing indicia of the promotional offer comprises generating a unique identifier based on a unique merchant identification code, a unique social seller identification code, and a unique promotional offer identification code.

15. The method of claim 9, wherein providing indicia comprises generating and transmitting to the social seller a short message service (SMS) text message with an embedded unique identifier.

16. The method of claim 9, wherein providing indicia comprises generating and transmitting to the social seller an electronic mail message with an embedded unique identifier.

17. A social information and promotional offer distribution system, comprising:
a social selling server;
a user interface coupled to the social selling server and configured to receive social seller information from a social seller and to transmit received social seller information to the social selling server;
the social selling server configured to receive social seller information from the user interface, to generate a unique social seller code identifying the social seller, and to store received social seller information in a database organized by the social seller code;
a merchant interface coupled to the social selling server and configured to receive merchant information from a merchant and to transmit received merchant information to the social selling server;
the social selling server further configured to receive merchant information from the merchant interface, to generate a unique merchant code identifying the merchant, and to store received merchant information in a database organized by the merchant code;
the merchant interface further configured to receive promotional offer information from a merchant and to transmit received promotional offer information to the social selling server;
the social selling server further configured to receive promotional offer information from the merchant interface, to generate a unique promotional offer code identifying the promotional offer, and to store received promotional offer information in a database organized by the promotional offer code;
the user interface further configured to receive promotional offer information from the social selling server, to present received promotional offer information to a social seller, to receive a selection from a social seller based on presented promotional offer information, and to transmit indicia of the selection to the social selling server;
the social selling server further configured to receive the indicia of the selection from the user interface and to associate a promotional offer with a social seller based on the received indicia of the selection;
the social selling server further configured to transmit promotional offer indicia to a social seller based on associating a promotional offer with the social seller, the promotional offer indicia comprising promotional offer terms and conditions and a referral code;
the referral code comprising an embedded code based on the promotional offer code and the social seller code;
the merchant interface further configured to receive transaction confirmation indicia from the merchant based on a completed transaction and the promotional offer indicia and to transmit transaction confirmation indicia to the social selling server; and
the social selling server further configured to receive the transaction confirmation indicia and to update the merchant information, the social seller information, and the promotional offer information based on the received transaction confirmation indicia.

18. The system of claim 17, wherein the social selling server further comprises a social selling hub.

19. The system of claim 17, wherein the social selling server is further configured to transmit promotional offer information to the user interface based on qualifying social seller information.

20. The system of claim 17, further comprising a content management system coupled to the social selling server and comprising a merchant database, a promotional offer database, and a social seller database.
